(19) United States
(12) Patent Application Publication
(10) Pub. No.: US 2015/0020124 A1
(43) Pub. Date: Jan. 15, 2015

(54) METHOD AND APPARATUS FOR PROVIDING BROADCAST CONTENTS

(71) Applicant: Electronics and Telecommunications Research Institute, Daejeon (KR)

(72) Inventors: Byung Jun BAE, Daejeon (KR); Woo Suk KIM, Gyeryong-si Chungcheongnam-do (KR); Hun Hee LEE, Daejeon (KR); Hyun Jeong YIM, Seoul (KR); Hyoung Soo LIM, Daejeon (KR); Heung Mook KIM, Daejeon (KR); Nam Ho HUR, Daejeon (KR)

(21) Appl. No.: 14/301,961

(22) Filed: Jun. 11, 2014

(30) Foreign Application Priority Data
Jul. 15, 2013 (KR) 10-2013-0082761
Nov. 26, 2013 (KR) 10-2013-0144557

(51) Int. Cl. H04N 21/472; H04N 21/432

(52) U.S. Cl. CPC H04N 21/472; H04N 21/432
USPC 725/86

(57) ABSTRACT

Provided are a method and an apparatus for providing broadcast contents and broadcasting service provision information by employing a cloud storage control server using a cloud storage, in which the broadcast contents and the broadcasting service provision information may be provided through a communications network and a broadcasting network operated by a broadcaster and thus, various broadcast contents may be effectively provided to a broadcast content receiver, the broadcast contents may also be stored in the cloud storage and thus, security for the broadcast contents may be improved and a bulk local storage may not be required.

### CROSS-REFERENCE TO RELATED APPLICATION

This application claims the priority benefit of Korean Patent Application No. 10-2013-0082761, filed on Jul. 15, 2013, and Korean Patent Application No. 10-2013-0144557, filed on Nov. 26, 2013, in the Korean Intellectual Property Office, the disclosures of which are incorporated herein by reference.

### BACKGROUND

1. Field of the Invention

The present invention relates to broadcast content providing technology, and more particularly, to a method and an apparatus for providing broadcast contents using a cloud storage.

2. Description of the Related Art

Recently, avid discussions are being conducted on a next generation digital broadcasting system that may provide broadcast contents through not only a unidirectional broadcasting network, but also a bidirectional communications network.

The Advanced Television Systems Committee (ATSC) of the United States is attempting to define standards for the next generation digital broadcasting system based on ATSC 3.0. The ATSC 3.0 supports a new broadcasting service including an ultra high definition (UHD) broadcast, a personalized broadcast, and a bidirectional broadcast, without being affected by backward compatibility with conventional digital broadcasts.

When defining next generation digital broadcasting standards, issues in relation to managing, controlling, and transmitting broadcast contents to be provided to a user are emerging. For example, a method of providing broadcast contents only through a conventional unidirectional broadcasting network and a method of processing and providing broadcast contents using a local storage may not be applicable to the next generation digital broadcasting service that aims to provide various and bulk broadcast contents based on a broadcasting and communication convergence network.

Accordingly, there is a desire for a method and an apparatus for providing broadcast contents using both a communications network and a broadcasting network, which may be differentiated from a conventional method using only the broadcasting network, secure economic feasibility for a broadcast content receiving terminal, and improve security for the broadcast contents.

The foregoing description is provided only to assist the reader in gaining an understanding of embodiments of the present invention. Thus, the description may include content not constituting a portion of a related art. Conversely, content that the related art may present to those of ordinary skill in the art may not be included in the description.

### SUMMARY

Exemplary embodiments of the present invention disclose a method and an apparatus for providing broadcast contents and broadcasting service provision information by employing a cloud storage control server using a cloud storage.

Exemplary embodiments of the present invention disclose a method and an apparatus for providing a broadcast content and broadcasting service provision information through a communications network and a broadcasting network operated by a broadcaster.

According to an aspect of the present invention, there is provided a broadcast content providing method performed by a broadcast content provider, including receiving search information associated with at least one broadcast content from a cloud storage control server, generating broadcasting service provision information comprising information associated with a selected broadcast content based on the received search information, transmitting the generated broadcasting service provision information to a broadcast content receiver, and providing the selected broadcast content to the broadcast content receiver. Here, the at least one broadcast content may be stored in a cloud storage controlled by the cloud storage control server, and the selected broadcast content may be a broadcast content selected from among the at least one broadcast content and a live broadcast content.

The providing of the selected broadcast content may include requesting the selected broadcast content from the cloud storage control server or a live broadcast content providing server.

The providing of the selected broadcast content may include receiving the selected broadcast content from the cloud storage control server or the live broadcast content providing server.

The providing of the selected broadcast content may include transmitting the received selected broadcast content to the broadcast content receiver.

Each of the at least one broadcast content may be a non-real time broadcast content or the live broadcast content.

The search information may be received at a predetermined time interval.

The broadcasting service provision information may be transmitted through a communications network operated by the broadcast content provider and a broadcasting network.

The broadcasting service provision information may include at least one of information associated with a broadcast content transmitted to the broadcast content receiver through the communications network, information associated with a broadcast content transmitted to the broadcast content receiver through the broadcasting network, and information associated with a broadcast content transmitted to the broadcast content receiver through the broadcast content receiver directly accessing the at least one broadcast content stored in the cloud storage.

The selected broadcast content may be transmitted to the broadcast content receiver through the communications network operated by the broadcast content provider or the broadcasting network.

The broadcast content providing method may further include receiving a request signal for the selected broadcast content from each of at least one broadcast content receiver.

The selected broadcast content may be selected from among the at least one broadcast content and the live broadcast content based on the request signal.

When a number of request signals received from the at least one broadcast content receiver or a frequency of receiving the request signals is greater than or equal to a predetermined value, the providing of the selected broadcast content may include transmitting the selected broadcast content to each of the at least one broadcast content receiver through the broadcasting network.

When the number or the frequency is less than the predetermined value, the providing of the selected broadcast content may include transmitting the selected broadcast content to each of the at least one broadcast content receiver through the communications network operated by the broadcast content provider.

When the selected broadcast content is a broadcast content selected from among the at least one broadcast content stored in the cloud storage, and the number of the request signals received from the at least one broadcast content receiver or the frequency of receiving the request signals is less than the predetermined value, the providing of the selected broadcast content may include providing the selected broadcast content to each of the at least one broadcast content receiver by allowing each of the at least one broadcast content receiver direct access to the selected broadcast content stored in the cloud storage.

The selected broadcast content may be a broadcast content for a downloading service stored in the cloud storage.

The providing of the selected broadcast content may include providing the selected broadcast content to each of the at least one broadcast content receiver by allowing the at least one broadcast content receiver direct access to the broadcast content for the downloading service stored in the cloud storage.

According to another aspect of the present invention, there is provided a broadcast content receiving method including receiving, from a broadcast content provider, broadcasting service provision information including information associated with a selected broadcast content, receiving the selected broadcast content from the broadcast content provider based on the broadcasting service provision information, and playing the received selected broadcast content. Here, the selected broadcast content may be a broadcast content selected from among broadcast contents stored in a cloud storage and a live broadcast content.

The broadcasting service provision information may be received through a communications network operated by the broadcast content provider and a broadcasting network.

The selected broadcast content may be received through the communications network operated by the broadcast content provider or the broadcasting network.

The broadcast content receiving method may further include transmitting a request signal for the selected broadcast content to the broadcast content provider based on the broadcasting service provision information.

When a number of request signals transmitted from the broadcast content receiver and other broadcast content receivers or a transmission frequency of the request signals is greater than or equal to a predetermined value, the receiving of the selected broadcast content may include receiving the selected broadcast content through the broadcasting network.

When the number or the transmission frequency is less than the predetermined value, the receiving of the selected broadcast content may include receiving the selected broadcast content through the communications network operated by the broadcast content provider.

Each of the other broadcast content receivers may differ from the broadcast content receiver.

When the selected broadcast content is a broadcast content selected from among the broadcast contents stored in the cloud storage, and the number of the request signals transmitted from the broadcast content receiver and other broadcast content receivers or the transmission frequency of the request signals is less than the predetermined value, the receiving of the selected broadcast content may include receiving the selected broadcast content through directly accessing the selected broadcast content stored in the cloud storage.

Each of the other broadcast content receivers may differ from the broadcast content receiver.

According to still another aspect of the present invention, there is provided a broadcast content provider including a broadcast content searcher, a scheduling unit, a broadcasting service provision information generator, and a broadcast content transmitting unit. Here, the broadcast content searcher may receive search information associated with at least one broadcast content from a cloud storage control server, and the at least one broadcast content may be stored in a cloud storage controlled by the cloud storage control server. The generator may generate broadcasting service provision information including information associated with a selected broadcast content, and the selected broadcast content may be a broadcast content selected, by the scheduling unit, from among the at least one broadcast content and a live broadcast content. The broadcast content transmitting unit may transmit the generated broadcasting service provision information to a broadcast content receiver and provide the selected broadcast content to the broadcast content receiver.

The broadcast content provider may further include a broadcast content receiving unit.

The broadcast content receiving unit may request the selected broadcast content from the cloud storage control server or a live broadcast content providing server.

The broadcast content receiving unit may receive the selected broadcast content from the cloud storage control server or the live broadcast content providing server.

The broadcast content transmitting unit may transmit the received selected broadcast content to the broadcast content receiver.

The broadcast content transmitting unit may transmit the broadcasting service provision information to the broadcast content receiver through a communications network operated by the broadcast content provider and a broadcasting network.

The broadcast content transmitting unit may transmit the selected broadcast content to the broadcast content receiver through the communications network operated by the broadcast content provider or the broadcasting network.

The broadcast content provider may further include a signal receiving unit.

The signal receiving unit may receive a request signal for the selected broadcast content from each of at least one broadcast content receiver.

The selected broadcast content may be selected from among the at least one broadcast content and the live broadcast content based on the request signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a broadcast content processing method according to a related art;

FIG. 2 illustrates a broadcast content processing method according to an embodiment of the present invention;

FIG. 3 is a diagram illustrating a broadcast content provider according to an embodiment of the present invention;

FIG. 4 is a diagram illustrating a broadcast content receiver according to an embodiment of the present invention;

FIG. 5 is a diagram illustrating a broadcast content receiver according to another embodiment of the present invention; and

FIG. 6 illustrates a broadcast content processing method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

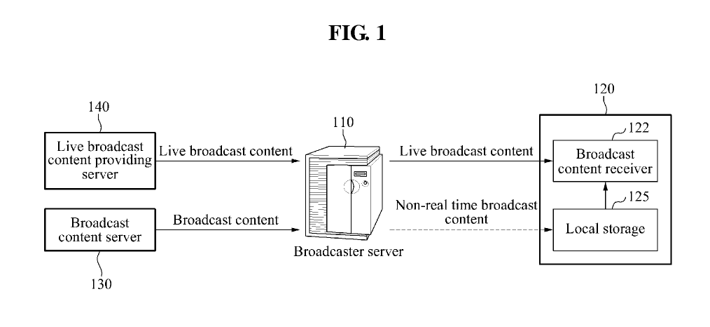

FIG. 1 illustrates a broadcast content processing method according to a related art.

The method by which a live broadcast content and a non-real time broadcast content are provided from a broadcaster server 110 to a broadcast content receiving system 120, is shown in FIG. 1.

The broadcast content receiving system 120 may include a broadcast content receiver 122 and a local storage 125. The non-real time broadcast content may be a broadcast content for a downloading service that may be downloaded to the local storage 125 of the broadcast content receiving system 120.

The live broadcast content and the non-real time broadcast content may be provided to the broadcast content receiving system 120 through a broadcasting network.

Although not illustrated, the broadcast content receiving system 120 may be the broadcast content receiver 122. Here, the local storage 125 may be included in a broadcast content terminal device.

Provision of a broadcast content to the broadcast content receiving system 120 may indicate that a substance of the broadcast content is displayed on the broadcast content receiving system 120 so that a user of the broadcast content receiving system 120 may view the broadcast content, or that information required for the display of the substance of the broadcast content is output to the broadcast content receiving system 120.

The broadcaster server 110 may select a broadcast content to be downloaded to the broadcast content receiving system 120 or transmit the selected broadcast content to the broadcast content receiving system 120 through the broadcasting network. The selected broadcast content may be transmitted at a point in time when a viewer desires to view the selected broadcast content or prior to the point in time. The transmitted broadcast content may be stored in the local storage 125 of the broadcast content receiving system 120. The user of the broadcast content receiving system 120 may view the broadcast content stored in the local storage 125.

The broadcaster server 110 may be a server used to manage a live broadcast content and a non-real time broadcast content produced by a broadcaster. Also, the broadcaster server 110 may be a server used to manage broadcast contents received from a broadcast content server 130 and live broadcast contents received from a live broadcast content providing server 140.

The broadcast content server 130 and the live broadcast content providing server 140 may be a broadcaster or a server separate from the broadcaster server 110. For example, the live broadcast content providing server 140 may be a broadcaster providing a live broadcast content. The broadcast content server 130 and the broadcaster server 110 may relay the live broadcast content and the non-real time broadcast content so as to be provided.

The live broadcast content and the non-real time broadcast content provided among the broadcaster server 110, the broadcast content receiving system 120, the broadcast content server 130, and the live broadcast content providing server 140 may be digital data.

The live broadcast content and the non-real time broadcast content may be a broadcasting program including at least one of a voice content, an image content, and a video content. For example, the live broadcast content and the non-real time broadcast content may be a broadcast program produced by a broadcaster.

The live broadcast content may be a broadcast program to be broadcasted by a broadcaster in accordance with a predetermined broadcasting schedule. For example, the live broadcast content may be a live broadcast program provided to a viewer concurrently with production of the program or a prerecorded broadcast program.

The live broadcast content may be a broadcast program to be broadcasted for a duration predetermined by a broadcaster. A viewer may view the live broadcast content only for the amount of time during which the live broadcast content is broadcasted. During transmission of the live broadcast content, the viewer may not be able to rewind and fast forward the live broadcast content.

The non-real time broadcast content may be a broadcast program that may be permanently provided, irrespective of a predetermined broadcasting schedule of a broadcaster, to a viewer in response to a request by the viewer. During the non-real time broadcast content being broadcasted, the viewer may rewind and fast forward the non-real time broadcast content. Thus, the viewer may view the non-real time broadcast content at any desired time and selectively view a portion of the non-real time broadcast content. For example, the non-real time broadcast content may be a video on demand (VOD) content.

Although not illustrated, the broadcast content receiving system 120 receiving the live broadcast content and the non-real time broadcast content may be plural. For example, the broadcaster server 110 may provide the live broadcast content and the non-real time broadcast content to each of terminal devices.

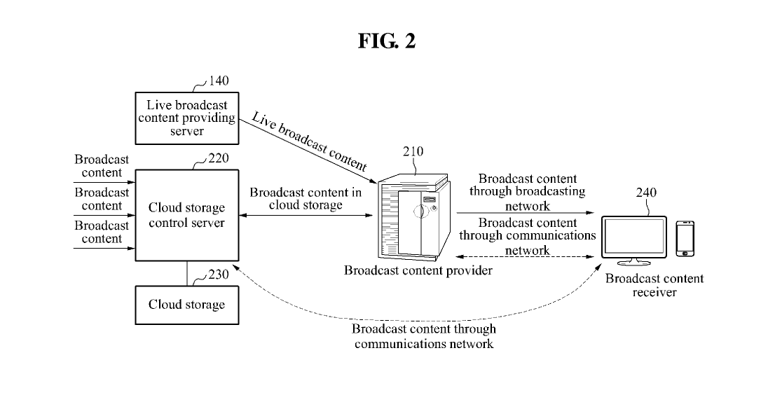

FIG. 2 illustrates a broadcast content processing method according to an embodiment of the present invention.

A broadcast content provider 210 may provide a broadcast content to a broadcast content receiver 240 through a communications network and/or a broadcasting network. The communications network through which the broadcast content is provided may be a communications network operated by the broadcast content provider 210. For example, the communications network operated by the broadcast content provider 210 may be used to transmit data used by a server that is operated and controlled directly by a broadcaster. The communications network and the broadcasting network may be present as a broadcasting and communications convergence network.

The broadcast content provider 210 and the broadcast content receiver 240 may correspond to a broadcaster server 110 of FIG. 1 and a broadcast content receiving system 120 of FIG. 1, respectively.

The broadcast content receiver 240 may be a device that may receive a broadcast content from the broadcast content provider 210. When the broadcast content provided from the broadcast content provider 210 includes a compressed image and/or voice data, the broadcast content receiver 240 may restore an original image and/or an original voice data from the compressed image and/or voice data. For example, the broadcast content receiver 240 may be a set-top box.

The broadcast content provider 210 may receive a broadcast content stored in a cloud storage 230 from a live broadcast content providing server 140 of FIG. 1 and/or a cloud storage control server 220, and provide the received broadcast content to the broadcast content receiver 240.

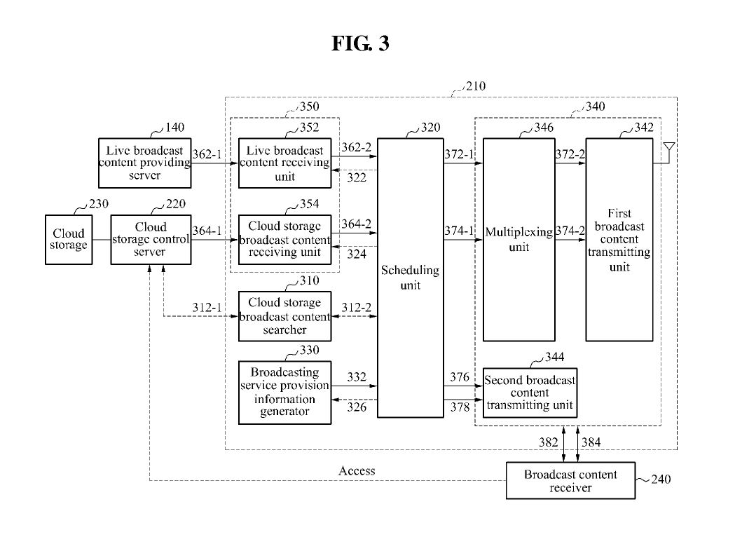

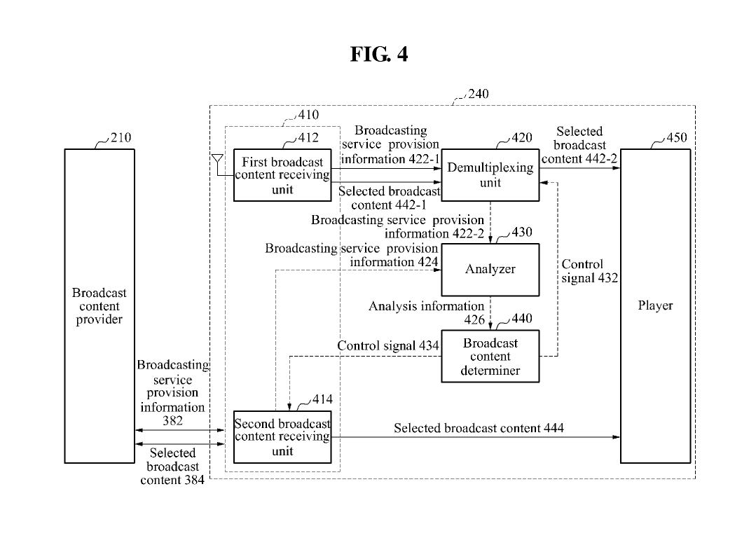

Also, the broadcast content may be provided directly to the broadcast content receiver 240 from the cloud storage control server 220. A more detailed description of a method by which the broadcast content is provided directly to the broadcast content receiver 240 from the cloud storage control server 220 will follow with reference to FIGS. 3 and 4.

The cloud storage control server 220 may be a server that may manage the cloud storage 230. For example, the cloud storage control server 220 may store a broadcast content produced by a broadcaster in the cloud storage 230 and transmit data stored in the cloud storage 230 to the broadcast content provider 210 and/or the broadcast content receiver 240.

As illustrated, when the broadcast content is stored in the cloud storage 230, the broadcast content provider 210 and the broadcast content receiver 240 may not include a storage to store a broadcast content, or include only a storage having a predetermined minimum capacity. For example, the broadcast content provider 210 and/or the broadcast content receiver 240 may include a storage in which only a program required for implementation and operation is stored, or a storage having a predetermined minimum capacity used for temporary storage of a broadcast content being transmitted until transmission of the broadcast content is completed.

Also, when the broadcast content is stored in the cloud storage 230, security of the broadcast content may be improved.

A more detailed description of structures of the broadcast content provider 210 and the broadcast content receiver 240 and a method by which the broadcast content is provided to the broadcast content receiver 240 will be provided with reference to FIGS. 3 and 4.

Technical descriptions provided with reference to FIG. 1 may be applicable hereto and thus, repeated descriptions will be omitted for conciseness.

FIG. 3 is a diagram illustrating a broadcast content provider 210 according to an embodiment of the present invention.

The broadcast content provider 210 may include a cloud storage content searcher 310, a scheduling unit 320, a broadcasting service provision information generator 330, a broadcast content transmitting unit 340, and a broadcast content receiving unit 350.

According to an embodiment to be described hereinafter, transmission of a signal, information, and/or a broadcast content among components of the broadcast content provider 210 may indicate reception of the signal, the information, and the broadcast content among the components of the broadcast content provider 210. Thus, a repeated description will be omitted for conciseness.

The cloud storage content searcher 310 may be a unit that receives search information associated with broadcast contents stored in the cloud storage 230 of FIG. 2. Each of the broadcast contents stored in the cloud storage 230 may be a pre-recorded broadcast content as a non-real time broadcast content, or a live broadcast content described with reference to FIG. 1. For example, the live broadcast content stored in the cloud storage 230 may be a streaming content that may be provided, in real time, to a broadcast content receiver 240 of FIG. 2.

In operation 312-1, the cloud storage content searcher 310 may receive, from a cloud storage control server 220 of FIG. 2, the search information associated with at least one broadcast contents. The broadcast contents may be broadcast contents stored in the cloud storage 230 controlled by the cloud storage control server 220. The search information may be information used to distinguish each of the broadcast contents stored in the cloud storage 230 from other broadcast contents in the cloud storage 230. For example, the search information may include at least one of a title, a size, a playback time, a genre, and an identifier for each of the broadcast contents stored in the cloud storage 230. The search information may be received to the cloud storage content searcher 310 at a predetermined time interval. For example, the cloud storage content searcher 310 may periodically receive the search information from the cloud storage control server 220 or receive the search information when a number and/or a substance of the broadcast contents stored in the cloud storage 230 are changed.

Although not illustrated, the search information may be received from the cloud storage control server 220 based on a request by the scheduling unit 320. For example, the scheduling unit 320 may request the search information from the cloud storage content searcher 310. The cloud storage content searcher 310 may request the search information from the cloud storage control server 220 in response to the request and thus, the search information may be received from the cloud storage control server 220.

In operation 312-2, the cloud storage content searcher 310 may transmit the search information received from the cloud storage control server 220 to the scheduling unit 320. The scheduling unit 320 may generate a control signal based on the received search information. The scheduling unit 320 may transmit the generated control signal to the broadcasting service provision information generator 330 and the broadcast content receiving unit 350. The control signal transmitted by the scheduling unit 320 may be a signal requesting a broadcast content from a live broadcast content providing server 140 and the cloud storage control server 220 or requesting generation of information associated with the broadcast content.

In operation 326, the scheduling unit 320 may transmit the control signal to the broadcasting service provision information generator 330.

The broadcasting service provision information generator 330 may generate broadcasting service provision information based on the received control signal. The broadcasting service provision information may be generated based on the search information received by the scheduling unit 320, and include information associated with a broadcast content selected from among the broadcast contents stored in the cloud storage 230 and the live broadcast content provided by the live broadcast content providing server 140.

The broadcasting service provision information may be information associated with the broadcast contents stored in the cloud storage 230 and the live broadcast content, and include a title and an identifier of a broadcast and at least one piece of information generated by a broadcaster providing the broadcast content. Also, the broadcasting service provision information may include at least one piece of information among information on a portion of an image content, information on a portion of a video content, and information on a portion of a voice content included in the broadcast content. For example, the broadcasting service provision information may include at least one of a preview image, a summary, a synopsis, and a still image of the broadcast content. The broadcasting service provision information may be displayed on the broadcast content receiver 240. A user of the broadcast content receiver 240 may recognize the displayed broadcasting service provision information.

In operation 332, the broadcasting service provision information generator 330 may transmit the generated broadcasting service provision information to the scheduling unit 320.

In operations 372-1 and 376, the scheduling unit 320 may transmit the received broadcasting service provision information to the broadcast content transmitting unit 340. The broadcast content transmitting unit 340 may include a first broadcast content transmitting unit 342, a second broadcast content transmitting unit 344, and a multiplexing unit 346.

In operation 382, the broadcast content transmitting unit 340 may transmit the generated broadcasting service provision information to the broadcast content receiver 240. The broadcasting service provision information transmitted by the broadcast content transmitting unit 340 may be transmitted through a communications network operated by the broadcast content provider 210 and a broadcasting network. The broadcasting service provision information may include at least one of information associated with a broadcast content transmitted to the broadcast content receiver 240 through the communications network, information associated with a broadcast content transmitted to the broadcast content receiver 240 through the broadcasting network, and information associated with a broadcast content transmitted to the broadcast content receiver 240 through the broadcast content receiver 240 directly accessing the cloud storage 230 in which broadcast contents are stored.

A more detailed description of a method by which the broadcasting service provision information generated by the broadcasting service provision information generator 330 is transmitted to the broadcast content receiver 240 through the communications network operated by the broadcast content provider 210 and the broadcasting network will be provided as follows.

In operation 372-1, the scheduling unit 320 may transmit the received broadcasting service provision information to the multiplexing unit 346. The multiplexing unit 346 may multiplex the received broadcasting service provision information. In operation 372-2, the multiplexing unit 346 may transmit the multiplexed broadcasting service provision information to the first broadcast content transmitting unit 342. The first broadcast content transmitting unit 342 may transmit the multiplexed broadcasting service provision information to the broadcast content receiver 240 through the broadcasting network. The first broadcast content transmitting unit 342 may include an antenna used to transmit data.

Also, in operation 376, the scheduling unit 320 may transmit the received broadcasting service provision information to the second broadcast content transmitting unit 344. The second broadcast content transmitting unit 344 may transmit the broadcasting service provision information to the broadcast content receiver 240 through the communications network operated by the broadcast content provider 210.

For example, the broadcasting service provision information may be transmitted through the communications network operated by the broadcast content provider 210 and the broadcasting network for convenience of a user of the broadcast content receiver 240.

The broadcast content transmitting unit 340 may provide, to the broadcast content receiver 240, a broadcast content selected from among the broadcast contents stored in the cloud storage 230 and the live broadcast content provided by the live broadcast content providing server 140. The selected broadcast content may be selected by the scheduling unit 320. The selected broadcast content may be a broadcast content provided to the broadcast content receiver 240 among the broadcast contents stored in the cloud storage 230 and the live broadcast content provided by the live broadcast content providing server 140. At least one the broadcast content may be selected.

Although not illustrated, the broadcast content provider 210 may selectively include a signal receiving unit. The signal receiving unit may receive a request signal for the selected broadcast content from each of at least one broadcast content receiver. Based on the request signal received by a broadcasting signal receiving unit, the selected broadcast content may be selected from among the broadcast contents stored in the cloud storage 230 and the live broadcast content. A more detailed description of the request signal transmitted from the broadcast content receiver 240 will be provided with reference to FIG. 4.

Also, a more detailed description of a method by which the selected broadcast content is provided to the broadcast content receiver 240 will be provided as follows.

In operations 322 and 324, the scheduling unit 320 may transmit a control signal to the broadcast content receiving unit 350.

In operation 322, the scheduling unit 320 may transmit the control signal to the broadcast content receiving unit 350 and a live broadcast content receiving unit 352. The control signal transmitted in operation 322 may be a request signal requesting a live broadcast content from the live broadcast content providing server 140. In operation 362-1, the live broadcast content receiving unit 352 may receive the live broadcast content from the live broadcast content providing server 140. Although not illustrated, the live broadcast content may be transmitted from the live broadcast content providing server 140 in response to a request by the live broadcast content receiving unit 352. The live broadcast content receiving unit 352 may receive the control signal in operation 322 and receive the live broadcast content in operation 362-1 by requesting the live broadcast content from the live broadcast content providing server 140.

In operation 324, the scheduling unit 320 may transmit the control signal to a cloud storage broadcast content receiving unit 354 of the broadcast content receiving unit 350. The control signal transmitted in operation 324 may be a request signal requesting a broadcast content from the cloud storage control server 220. In operation 364-1, the cloud storage broadcast content receiving unit 354 may receive the broadcast content from the cloud storage control server 220. Although not illustrated, the broadcast content stored in the cloud storage 230 may be transmitted from the cloud storage control server 220 in response to a request by the cloud storage broadcast content receiving unit 354. The cloud storage broadcast content receiving unit 352 may receive the control signal in operation 324 and receive the broadcast content in operation 364-1 by requesting the broadcast content from the cloud storage control server 220.

Operation 362-1 or operation 364-1 may be selectively performed. In operation 362-1 and/or operation 364-1, the broadcast content received by the broadcast content receiving unit 350 may be the aforementioned selected broadcast content. Also, in operation 322 and/or operation 324, the control signal may be a signal requesting the selected broadcast content.

The broadcast content receiving unit 350 may request the selected broadcast content from the cloud storage control server 220 or the live broadcast content providing server 140. In response to the request, the broadcast content receiving unit 350 may receive the selected broadcast content from the cloud storage control server 220 or the live broadcast content providing server 140.

In operation 362-2, the scheduling unit 320 may receive the live broadcast content from the live broadcast content receiving unit 352. In operation 364-2, the scheduling unit 320 may receive the broadcast content from the cloud storage broadcast content receiving unit 352.

Operation 362-2 or operation 364-2 may be selectively performed. In operation 362-2 and/or operation 364-2, the broadcast content received by the scheduling unit 320 may be the aforementioned selected broadcast content. Alternatively, the scheduling unit 320 may determine the selected broadcast content based on the received broadcast content.

In operation 374-1 and/or operation 378, the scheduling unit 320 may transmit the selected broadcast content to the broadcast content transmitting unit 340.

In operation 384, the broadcast content transmitting unit 340 may transmit the received selected broadcast content to the broadcast content receiver 240. The selected broadcast content transmitted to the broadcast content receiver 240 may be transmitted through the communications network operated by the broadcast content provider 210 or the broadcasting network.

A more detailed description of a method by which the selected broadcast content is transmitted to the broadcast content receiver 240 through the communications network operated by the broadcast content provider 210 or the broadcasting network will be provided as follows.

In operation 374-1, the scheduling unit 320 may transmit the received selected broadcast content to the multiplexing unit 346. The multiplexing unit 346 may multiplex the received selected broadcast content. In operation 374-2, the multiplexing unit 346 may transmit the multiplexed selected broadcast content to the first broadcast content transmitting unit 342. The first broadcast content transmitting unit 342 may transmit the multiplexed broadcasting service provision information to the broadcast content receiver 240 through the broadcasting network.

Alternatively, in operation 378, the scheduling unit 320 may transmit the received selected broadcast content to the second broadcast content transmitting unit 344. The second broadcast content transmitting unit 344 may transmit the selected broadcast content through the communications network operated by the broadcast content provider 210.

As described in the foregoing, the selected broadcast content may be transmitted to the broadcast content receiver 240 through the communication network operated by the broadcast content provider 210 or the broadcasting network.

The scheduling unit 320 may determine whether to transmit the selected broadcast content through the communication network operated by the broadcast content provider 210 or the broadcasting network. The scheduling unit 320 may determine a network through which the selected broadcast content is to be transmitted based on the request signal received by the signal receiving unit from the broadcast content receivers.

For example, when a number of request signals received from the broadcast content receivers or a frequency of receiving the request signals is greater than or equal to a predetermined value, the scheduling unit 320 may transmit the selected broadcast content to each of the broadcast content receivers through the broadcasting network. When the number of the request signals or the frequency of receiving the request signals is less than the predetermined value, the scheduling unit 320 may transmit the selected broadcast content to each of the broadcast content receivers through the communications network operated by the broadcast content provider 210. Also, when numerous users of the broadcast content receivers desire to view the selected broadcast content, the selected broadcast content may be provided through the broadcasting network. When there are a few users of the broadcast content receivers who desire to view the selected broadcast content, the selected broadcast content may be provided through the communications network.

Also, when the selected broadcast content is a broadcast content selected from among the broadcast contents stored in the cloud storage 230, and the number of the request signals received from the broadcast content receivers or the frequency of receiving the request signals is less than the predetermined value, the broadcast content provider 210 may allow each of the broadcast content receivers direct access to the selected broadcast content stored in the cloud storage 230. The selected broadcast content may be provided to each of the broadcast content receivers through the broadcast content receivers directly accessing the selected broadcast content stored in the cloud storage 230. In other words, when a number of the users of the broadcast content receivers desiring to view the selected broadcast content is less than the predetermined value, the broadcast content provider 210 may allow each of the broadcast content receiver direct access to the selected broadcast content stored in the cloud storage 230, and provide the selected broadcast content to each of the broadcast content receivers.

A more detailed description of a method by which the broadcast content receiver 240 receives the selected broadcast content will be provided with reference to FIG. 4.

Technical descriptions provided with reference to FIGS. 1 and 2 may be applicable hereto and thus, repeated descriptions will be omitted for conciseness.

FIG. 4 is a diagram illustrating a broadcast content receiver 240 according to an embodiment of the present invention.

The broadcast content receiver 240 may include a broadcast content receiving unit 410, a demultiplexing unit 420, an analyzer 430, a broadcast content determiner 440, and a player 450.

The player 450 may include a display that may output a provided broadcast content. For example, the broadcast content receiver 240 may be a set-top box integrated television (TV), a digital TV, a smart TV, or a mobile terminal including a smartphone. Although not illustrated, the broadcast content receiver 240 may be provided separately from the player 450 or connected by wire or wireless to the player 450.

The broadcast content receiving unit 410 may include a first broadcast content receiving unit 412 and a second broadcast content receiving unit 414.

In operation 382, the broadcast content receiving unit 410 may receive, from a broadcast content provider 210, broadcasting service provision information including information associated with the selected broadcast content described with reference to FIG. 3.

The broadcasting service provision information may be received through a communications network operated by the broadcast content provider 210 and a broadcasting network.

In operation 384, the broadcast content receiving unit 410 may receive the selected broadcast content from the broadcast content provider 210 based on the received broadcasting service provision information. The selected broadcast content may be received through the communications network operated by the broadcast content provider 210 or the broadcasting network. The player 450 may play the received selected broadcast content.

The broadcast content receiving unit 410 may receive the broadcasting service provision information prior to reception of a broadcast content. Subsequent to the broadcast content receiving unit 410 receiving the broadcasting service provision information prior to the broadcast content, the broadcast content receiving unit 410 may receive the selected broadcast content based on the received broadcasting service provision information.

A more detailed description of processing of the broadcasting service provision information received by the broadcast content receiver 240 is as follows.

The first broadcast content receiving unit 412 may receive the broadcasting service provision information transmitted from a first broadcast content transmitting unit 342 of FIG. 3. The broadcasting service provision information received by the first broadcast content receiving unit 412 may be multiplexed broadcasting service provision information transmitted through the broadcasting network. The first broadcast content receiving unit 412 may include an antenna used to receive data. In operation 422-1, the first broadcast content receiving unit 412 may transmit the multiplexed broadcasting service provision information to the demultiplexing unit 420. The demultiplexing unit 420 may demultiplex the received multiplexed broadcasting service provision information. In operation 422-2, the demultiplexing unit 420 may transmit the demultiplexed broadcasting service provision information to the analyzer 430.

The second broadcast content receiving unit 414 may receive the broadcasting service provision information transmitted from a second broadcast content transmitting unit 344 of FIG. 3. The broadcasting service provision information received by the second broadcast content receiving unit 414 may be transmitted through the communications network operated by the broadcast content provider 210. In operation 424, the second broadcast content receiving unit 414 may transmit the received broadcasting service provision information to the analyzer 430.

The analyzer 430 may generate analysis information based on the broadcasting service provision information received from the second broadcast content receiving unit 414 and the demultiplexing unit 420. In operation 426, the analyzer 430 may transmit the generated analysis information to the broadcast content determiner 440.

The broadcast content determiner 440 may generate a control signal. The control signal generated by the broadcast content determiner 440 may be a signal requesting a broadcast content from the broadcast content provider 210. For example, a broadcast content requested by the control signal may be a selected broadcast content.

In operation 432, the broadcast content determiner 440 may transmit the generated control signal to the demultiplexing unit 420. The control signal in operation 432 may be used to determine a broadcast content to be viewed by a user of the broadcast content receiver 240 among selected broadcast contents received from the first broadcast content receiving unit 412.

In operation 434, the broadcast content determiner 440 may transmit the generated control signal to the second broadcast content receiving unit 414.

Although not illustrated, the broadcast content receiver 240 may selectively include a signal transmitting unit. The signal transmitting unit may transmit a request signal for the selected broadcast content to the broadcast content provider 210 based on the broadcasting service provision information. The signal transmitting unit may transmit the request signal for the selected broadcast content from the broadcast content provider 210 based on the control signal in operation 432 and/or operation 434. The broadcast content provider 210 may provide the selected broadcast content to the broadcast content receiver 240 based on the received request signal.

The request signal transmitted from the signal transmitting unit may correspond to the request signal received by the signal receiving unit of the broadcast content provider 210 which is described with reference to FIG. 3.

The request signal may be generated based on an input by the user of the broadcast content receiver 240. The user of the broadcast content receiver 240 may select a broadcast content to be viewed from among live broadcast contents or non-real time broadcast contents based on the broadcasting service provision information displayed on the broadcast content receiver 240 by operating the broadcast content receiver 240. The request signal may be generated based on the selecting by the user operating the broadcast content receiver 240. For example, when the user accesses a menu on which the non-real time broadcast contents are provided and selects a broadcast content from among the provided non-real time broadcast contents, a request signal for the selected broadcast content may be generated. Also, when the user desires to view a paid or limited live broadcast content, a request signal for the live broadcast content may be generated after authorization of the broadcast content. The authorized live broadcast content may be the selected broadcast content.

A more detailed description of a method by which the selected broadcast content is received from the broadcast content provider 210 through the communications network operated by the broadcast content provider 210 or the broadcasting network is as follows.

The first broadcast content receiving unit 412 may receive the selected broadcast content transmitted from the first broadcast content transmitting unit 342. The selected broadcast content received by the first broadcast content receiving unit 412 may be a multiplexed selected broadcast content transmitted through the broadcasting network. In operation 442-1, the first broadcast content receiving unit 412 may transmit the received multiplexed selected broadcast content to the demultiplexing unit 420. The demultiplexing unit 420 may demultiplex the multiplexed selected broadcast content. In operation 442-2, the demultiplexing unit 420 may transmit the selected broadcast content to the player 450. For example, the selected broadcast content to be transmitted to the player 450 may be a broadcast content determined based on the control signal in operation 432 among the selected broadcast contents received by the first broadcast content receiving unit 412.

The second broadcast content receiving unit 414 may receive the selected broadcast content transmitted from the second broadcast content transmitting unit 344. The selected broadcast content received by the second broadcast content receiving unit 414 may be the selected broadcast content transmitted through the communications network operated by the broadcast content provider 210. In operation 444, the second broadcast content receiving unit 414 may transmit the selected broadcast content to the player 450.

As described with reference to FIG. 3, the selected broadcast content may be transmitted through the communications network operated by the broadcast content provider 210 or the broadcasting networks based on the number of the request signals received from the broadcast content receivers and the frequency of receiving the request signals.

For example, when the number of the request signals transmitted from the broadcast content receiver 240 and other broadcast content receivers or a transmission frequency of the request signals is greater than or equal to a predetermined value, the first broadcast content receiving unit 412 may receive the selected broadcast content through the broadcasting network.

When the number of the request signals transmitted from the broadcast content receiver 240 and other broadcast content receivers, or the transmission frequency of the request signals is less than the predetermined value, the second broadcast content receiving unit 414 may receive the selected broadcast content through the communications network operated by the broadcast content provider 210.

Also, when the selected broadcast content may be a broadcast content selected from among the broadcast contents stored in the cloud storage 230, and the number of the request signals transmitted from the broadcast content receiver 240 and the other broadcast content receivers or the transmission frequency of the request signals is less than the predetermined value, the second broadcast content receiving unit 414 may receive the selected broadcast content through directly accessing the selected broadcast content stored in the cloud storage 230.

Each of the other broadcast content receivers may differ from the broadcast content receiver 240.

When the selected broadcast content is transmitted to the player 450 by performing operation 442-2 or 432, the user of the broadcast content receiver 240 may view the selected broadcast content.

Technical descriptions provided with reference to FIGS. 1 through 3 may be applicable hereto and thus, repeated descriptions will be omitted for conciseness.

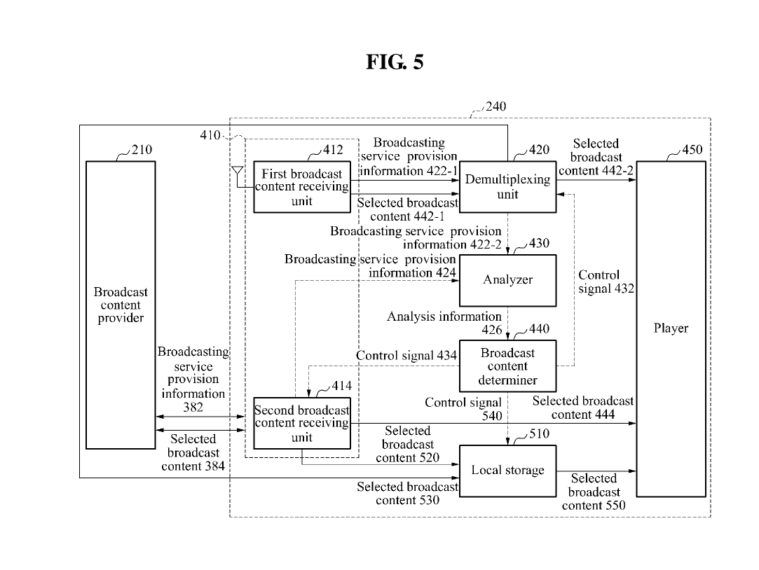

FIG. 5 is a diagram illustrating a broadcast content receiver 240 according to another embodiment of the present invention. FIG. 5 illustrates the broadcast content receiver 240 further including a local storage 510. The broadcast content receiver 240 of FIG. 5 may correspond to a broadcast content receiver 240 of FIG. 4 and thus, repeated descriptions will be omitted for conciseness.

The local storage 510 may be a device to store videos, information associated with configuration of an electronic device, and information associated with operation of the electronic device. The local storage 510 may be a hardware module used to store information, for example, a hard disk drive (HDD), a solid state drive (SSD), a random access memory (RAM), and a flash. The local storage 510 may store a program required for execution and operation of the broadcast content receiver 240.

The local storage 510 may store a broadcast content provided by a broadcast content provider 210. For example, the broadcast content stored in the local storage 510 may be a selected broadcast content, described with reference to FIGS. 3 and 4, which is received from a broadcast content receiver 410 of FIG. 4.

In operation 520, a second broadcast content receiving unit 414 of FIG. 4 may store a broadcast content in the local storage 510. For example, the broadcast content stored in the local storage 510 may be a selected broadcast content transmitted through a communications network operated by the broadcast content provider 210.

In operation 530, a demultiplexing unit 420 of FIG. 4 may store the broadcast content in the local storage 510. For example, the broadcast content stored in the local storage 510 may be a demultiplexed selected broadcast content transmitted through the broadcasting network.

In operation 540, a broadcast content determiner 440 of FIG. 4 may transmit a control signal to the local storage 510 based on broadcasting service provision information. For example, the broadcast content determiner 440 may generate the control signal based on analysis information obtained by an analyzer 430 of FIG. 4 and transmit the control signal to the local storage 510.

In operation 550, the local storage 510 may transmit, to a player 450 of FIG. 4, a broadcast content that the user of the broadcast content receiver 240 desires to view among broadcast contents stored in the local storage 510 based on the received control signal. For example, the broadcast content transmitted from the local storage 510 to the player 450 may be the selected broadcast content. The player 450 may play the selected broadcast content stored in the local storage 510. Also, the local storage 510 may allow the player 450 access to the selected broadcast content based on the received control signal, and the player 450 may play the selected broadcast content by accessing the selected broadcast content in the local storage 510.

Although not illustrated, the local storage 510 may further include a processor to process the received control signal, and operation 550 may be performed by the processor.

Technical descriptions provided with reference to FIGS. 1 through 4 may be applicable hereto and thus, repeated descriptions will be omitted for conciseness.

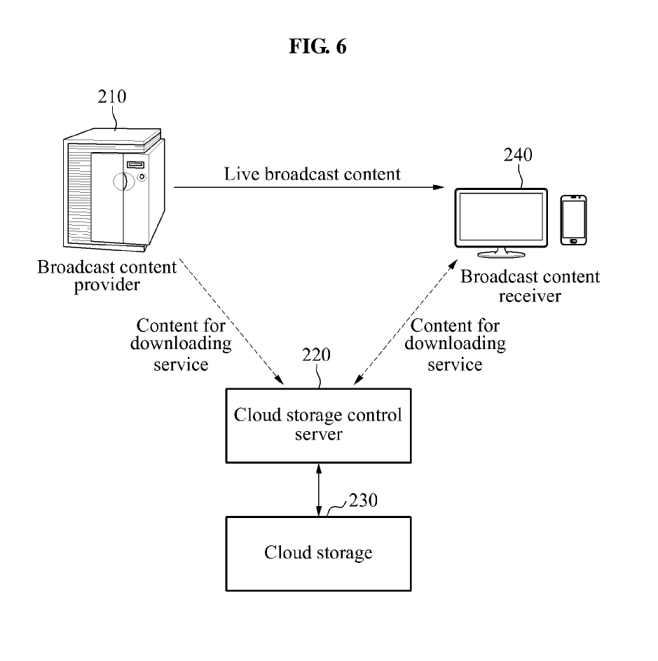

FIG. 6 illustrates a broadcast content processing method according to another embodiment of the present invention.

FIG. 6 shows a method by which a broadcast content for a downloading service is provided to a broadcast content receiver 240.

A broadcast content provider 210 may be a broadcaster manufacturing and/or managing broadcast contents or a server of the broadcaster. The broadcast contents manufactured and/or managed by the broadcast content provider 210 may be stored in a cloud storage 230.

A cloud storage control server 220 may use the cloud storage 230 to relay provision of the broadcast content for a downloading service between the broadcast content provider 210 and the broadcast content receiver 240. The broadcast content for the downloading service may be a non-real time broadcast content.

A live broadcast content may be provided from the broadcast content provider 210 to the broadcast content receiver 240 through a broadcasting network.

The broadcast content receiver 240 may request the provision of the broadcast content for the downloading service from the broadcast content provider 210. The request by the broadcast content receiver 240 from the broadcast content provider 210 may be performed through the broadcasting network.

Based on the request by the broadcast content receiver 240, the broadcast content provider 210 may provide the broadcast content for the downloading service to the broadcast content receiver 240. The broadcast content for the downloading service provided to the broadcast content receiver 240 may correspond to a selected broadcast content described with reference to FIGS. 3 through 5. For example, the broadcast content provider 210 may provide the selected broadcast content to the broadcast content receiver 240 by allowing the broadcast content receiver 240 direct access to the broadcast content for the downloading service stored in the cloud storage 230.

The broadcast content receiver 240 may receive the broadcast content for the downloading service from the cloud storage control server 220. The broadcast content receiver 240 may receive the broadcast content for the downloading service by directly accessing the broadcast content for the downloading service stored in the cloud storage 230. The receiving or the transmitting of the broadcast content for the downloading service may be performed through a communications network. For example, the receiving or the transmitting of the broadcast content for the downloading service may be performed through the communications network operated by the broadcast content provider 210 or the cloud storage control server 220.

For example, when the broadcast content provider 210 provides the broadcast content for the downloading service to the broadcast content receiver 240, requesting the broadcast content for the downloading service may be performed through the broadcasting network, and the transmitting of the broadcast content for the downloading service may be performed through the communications network.

The broadcast content receiver 240 may not maintain the local storage 510.

Technical descriptions provided with reference to FIGS. 1 through 5 may be applicable hereto and thus, repeated descriptions will be omitted for conciseness.

According to the present exemplary embodiments, there is provided a method and an apparatus for providing broadcast contents that may provide the broadcast contents and broadcasting service provision information by employing a cloud storage control server using a cloud storage and thus, a local storage may not be included.

According to the present exemplary embodiments, there is provided a method and an apparatus for providing broadcast contents that may effectively provide various broadcast contents to a broadcast content receiver by providing the broadcast contents and broadcasting service provision information through a communications network and a broadcasting network operated by a broadcaster.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A broadcast content providing method performed by a broadcast content provider, the method comprising:
receiving search information associated with at least one broadcast content from a cloud storage control server, wherein the at least one broadcast content is stored in a cloud storage controlled by the cloud storage control server;
generating broadcasting service provision information comprising information associated with a selected broadcast content based on the received search information, wherein the selected broadcast content is a broadcast content selected from among the at least one broadcast content and a live broadcast content;
transmitting the generated broadcasting service provision information to a broadcast content receiver; and
providing the selected broadcast content to the broadcast content receiver.

2. The method of claim 1, wherein the providing of the selected broadcast content comprises:
requesting the selected broadcast content from the cloud storage control server or a live broadcast content providing server;
receiving the selected broadcast content from the cloud storage control server or the live broadcast content providing server; and
transmitting the received selected broadcast content to the broadcast content receiver.

3. The method of claim 1, wherein each of the at least one broadcast content is a non-real time broadcast content or the live broadcast content.

4. The method of claim 1, wherein the search information is received at a predetermined time interval.

5. The method of claim 1, wherein the broadcasting service provision information is transmitted through a communications network operated by the broadcast content provider and a broadcasting network, and
wherein the broadcasting service provision information comprises at least one of information associated with a broadcast content transmitted to the broadcast content receiver through the communications network, information associated with a broadcast content transmitted to the broadcast content receiver through the broadcasting network, and information associated with a broadcast content transmitted to the broadcast content receiver through the broadcast content receiver directly accessing the at least one broadcast content stored in the cloud storage.

6. The method of claim 1, wherein the selected broadcast content is transmitted to the broadcast content receiver through a communications network operated by the broadcast content provider or a broadcasting network.

7. The method of claim 1, further comprising:
receiving a request signal for the selected broadcast content from each of at least one broadcast content receiver, and
wherein the selected broadcast content is selected from among the at least one broadcast content and the live broadcast content based on the request signal.

8. The method of claim 7, wherein the providing of the selected broadcast content comprises:
transmitting the selected broadcast content to each of the at least one broadcast content receiver through the broadcasting network, when a number of request signals received from the at least one broadcast content receiver or a frequency of receiving the request signals is greater than or equal to a predetermined value; and
transmitting the selected broadcast content to each of the at least one broadcast content receiver through the communications network operated by the broadcast content provider, when the number or the frequency is less than the predetermined value.

9. The method of claim 7, wherein the providing of the selected broadcast content comprises:
providing the selected broadcast content to each of the at least one broadcast content receiver by allowing each of the at least one broadcast content receiver direct access to the cloud storage for the selected broadcast content, when the selected broadcast content is a broadcast content selected from among the at least one broadcast content stored in the cloud storage, and the number of the request signals received from the at least one broadcast content receiver or the frequency of receiving the request signals is less than the predetermined value.

10. The method of claim 1, wherein the selected broadcast content is a broadcast content for a downloading service stored in the cloud storage, and the providing of the selected broadcast content comprises:
providing the selected broadcast content to each of the at least one broadcast content receiver by allowing the at least one broadcast content receiver direct access to the cloud storage for the broadcast content for the downloading service.

11. A broadcast content receiving method performed by a broadcast content receiver, the method comprising:
receiving, from a broadcast content provider, broadcasting service provision information comprising information associated with a selected broadcast content, wherein the selected broadcast content is a broadcast content selected from among broadcast contents stored in a cloud storage and a live broadcast content;
receiving the selected broadcast content from the broadcast content provider based on the broadcasting service provision information; and
playing the received selected broadcast content.

12. The method of claim 11, wherein the broadcasting service provision information is received through a communications network operated by the broadcast content provider and a broadcasting network.

13. The method of claim 11, wherein the selected broadcast content is received through a communications network operated by the broadcast content provider or a broadcasting network.

14. The method of claim 11, further comprising:
transmitting a request signal for the selected broadcast content to the broadcast content provider based on the broadcasting service provision information, and
wherein the receiving of the selected broadcast content comprises:
receiving the selected broadcast content through a broadcasting network, when a number of request signals transmitted from the broadcast content receiver and other broadcast content receivers or a transmission frequency of the request signals is greater than or equal to a predetermined value; and
receiving the selected broadcast content through a communications network operated by the broadcast content provider, when the number of request signals or the transmission frequency is less than the predetermined value, and
wherein each of the other broadcast content receivers differs from the broadcast content receiver.

15. The method of claim 11, wherein the receiving of the selected broadcast content comprises:
receiving the selected broadcast content through directly accessing the selected broadcast content in the cloud storage, when the selected broadcast content is a broadcast content selected from among the broadcast contents stored in the cloud storage and a number of request signals transmitted from the broadcast content receiver and other broadcast content receivers or a transmission frequency of the request signals is less than a predetermined value, and
wherein each of the other broadcast content receivers differs from the broadcast content receiver.

16. A broadcast content provider, comprising:
a broadcast content searcher;
a scheduling unit;
a broadcasting service provision information generator; and
a broadcast content transmitting unit, and
wherein the broadcast content searcher receives search information associated with at least one broadcast content from a cloud storage control server, and the at least one broadcast content is stored in a cloud storage controlled by the cloud storage control server;
the broadcasting service provision information generator generates broadcasting service provision information comprising information associated with a selected broadcast content, and the selected broadcast content is a broadcast content selected, by the scheduling unit, from among the at least one broadcast content and a live broadcast content; and
the broadcast content transmitting unit transmits the generated broadcasting service provision information to a broadcast content receiver and provides the selected broadcast content to the broadcast content receiver.

17. The provider of claim 16, further comprising:
a broadcast content receiving unit, and
wherein the broadcast content receiving unit requests the selected broadcast content from the cloud storage control server or a live broadcast content providing server and receives the selected broadcast content from the cloud storage control server or the live broadcast content providing server, and
wherein the broadcast content transmitting unit transmits the received selected broadcast content to the broadcast content receiver.

18. The provider of claim 16, wherein the broadcast content transmitting unit transmits the broadcasting service provision information to the broadcast content receiver through a communications network operated by the broadcast content provider and a broadcasting network.

19. The provider of claim 16, wherein the broadcast content transmitting unit transmits the selected broadcast content to the broadcast content receiver through a communications network operated by the broadcast content provider or a broadcasting network.

20. The provider of claim 16, further comprising:
a signal receiving unit, and
wherein the signal receiving unit receives a request signal for the selected broadcast content from each of at least one broadcast content receiver, and
wherein the selected broadcast content is selected from among the at least one broadcast content and the live broadcast content based on the request signal.
